(19) United States
(12) Patent Application Publication
(10) Pub. No.: US 2010/0011700 A1
(43) Pub. Date: Jan. 21, 2010

(54) CLADDING SYSTEM

(76) Inventor: Matthew Bruce Grant, Waitakere City (NZ)

Correspondence Address: NIXON PEABODY, LLP, 401 9TH STREET, NW, SUITE 900, WASHINGTON, DC, 20004-2128, US

(21) Appl. No.: 12/518,576

(22) PCT Filed: Dec. 12, 2007
(86) PCT No.: PCT/NZ2007/000358

§ 371 Date: Aug. 26, 2009

(30) Foreign Application Priority Data
Dec. 12, 2006 (NZ) 552042

(51) Int. Cl. E04F 13/22; E04F 21/18; E04G 21/18; E04G 21/00; F16M 13/02

(52) U.S. Cl. 52/748.11; 248/205.1

(57) ABSTRACT

A device (4) for positioning and supporting a cladding element (10a) for attachment to a building structure (1). The device (4) has a first support member (90) adapted to receive a lower edge of a cladding element (10a) and an attachment member (5) adapted to be attached to the building structure (1). The first support member (9) is coupled for the attachment member (5) and extends from the attachment member (5) at an angle to the attachment member (5).

The invention relates to the installation of cladding on a building structure, and especially to a wall, such as a vertical wall.

### BACKGROUND TO THE INVENTION

Traditionally, cladding panels are nailed or screwed onto the exterior of a building structure, usually by fixing the individual cladding panels to the building using fasteners that penetrate through the cladding panel and into the building structure. The cladding panels tend to be quite large, for example, they may have a length of approximately 2.4 metres and a width of approximately 1.2 metres. Hence, it is difficult to retain the panels in the correct position, so that the top and bottom edges of the panels are horizontal and that the spacing between the panels is uniform, during fixing of the panels to the building structure.

Similar problems also arise when attaching other forms of cladding, such as weatherboard, to the external surfaces of building structures.

### OBJECT OF THE INVENTION

An object of the present invention is to avoid or mitigate at least some of the disadvantages of the existing methods of installing cladding on building structures.

### SUMMARY OF THE INVENTION

In accordance with a first aspect of the present invention, there is provided a device for positioning and supporting a cladding element for attachment to a building structure, the device comprising a first support member adapted to receive a lower edge of a cladding element, an attachment member adapted to be attached to the building structure, wherein the first support member is coupled to the attachment member and extends from the attachment member at an angle to the attachment member.

An advantage of the invention is that it provides a device which supports an edge of a cladding element. This enables the cladding element to be more easily installed, as a lower edge of the cladding element can be supported by the support device during installation.

Preferably, the cladding element is weatherboard or a cladding panel. However, the cladding element could be any element to be applied as a skin to a building structure.

Preferably, the first support member extends from the attachment member.

Typically, the device comprises an alignment protrusion that is adapted to engage with the building structure to aid alignment of the device relative to the building structure, the protrusion extending from the attachment member on the side of a plane defined by the attachment member opposite the side from which the first support member extends.

Preferably, the protrusion is an elongate protrusion, which may be in the form of a lip.

In one example of the invention, the device may also include a second support member, the second support member being provided to support a cavity spacer.

Typically, the second support member separates the first support member from the attachment member.

Preferably, the second support member extends substantially perpendicularly from the attachment member.

Where the device is for use with weatherboard, the first member extends at an angle to the attachment member and at an angle to the second member. Where the device is for a cladding panel the second support member extends substantially perpendicularly to the attachment member and the first support member is substantially parallel to the second member and preferably, in line with the second member.

In one example of the invention, the device is adapted to support and/or align the lower most row of cladding elements or a cladding element in the lower most row.

In an alternative example of the invention, the device is adapted to be attached to a cladding element already fixed to the building structure in order to support and/or align an adjacent cladding element for fixing to the building structure.

In accordance with a second aspect of the present invention, there is provided a method of installing cladding elements on a building structure, the method comprising attaching to the building structure a first device for positioning and supporting a cladding element on the building structure, the first device including a support member that extends away from the building structure when the support device is attached to the building structure, the first device being attached to the building structure such that a support surface of the support member extends substantially horizontally along the building, positioning a first cladding element on the first device such that a lower edge of the cladding element engages with the support member and fixing the first cladding element to the building structure.

Preferably, the method further comprises removably attaching a second device to the first cladding element, the second device including a support member having a support surface for engaging with an edge of a second cladding element, positioning the second cladding element on the building structure such that an edge of the second cladding element engages with the support member and fixing the second cladding element to the building structure.

Preferably, the second device is removed from the first cladding element after the second cladding element has been fixed and is repeatedly attached and removed from subsequent cladding elements until all the cladding elements have been mounted on the building structure.

In one example of the invention, where the cladding elements are weatherboard, the second device has an alignment member that engages with a lower edge of the previously fixed weatherboard to align the support member which is engaged by the weatherboard to be fixed. Typically, where the cladding elements are weatherboard, the second device has a generally “Z” shaped cross-section.

In another example of the invention, where the cladding elements to be mounted on the building structure are cladding panels, the second device may be in the shape of a cross with the width of the legs of the cross defining a separation between adjacent cladding panels and the sides of the legs of the cross defining the support surface. Typically, at least one leg of the cross has an attachment member to enable the second device to be removably attached to an existing cladding panel.

Alternatively, where the cladding elements are cladding panels, the second device may comprise an elongate member having an attachment member extending transverse to the extent of the elongate member, the elongate member engaging with an edge of the cladding panel that has already been installed to define the support surface of a subsequent cladding panel to be installed and defining the separation of the subsequent cladding panel from the existing panel, the attachment member extending over the existing cladding panel for removable attachment to the existing cladding panel.

Typically, the plane of the building structure to which the cladding element is to be attached is generally upright, and may be substantially vertical. For example, the building structure may be a generally upright or substantially vertical wall.

Unless the context clearly requires otherwise, throughout the description and the claims, the words “comprise”, “comprising”, and the like, are to be construed in an inclusive sense as opposed to an exclusive or exhaustive sense, that is to say, in the sense of “including, but not limited to”.

### BRIEF DESCRIPTION OF THE FIGURES

Examples of a device for and a method of mounting cladding elements on a building structure in accordance with the invention will now be described with reference to the accompanying drawings, in which:

FIG. 1 Shows a first example of support bracket and an alignment bracket being used to install weatherboard on a building structure without a cavity;

FIG. 2 Is a cross-sectional view of the support bracket shown in FIG. 1;

FIG. 3 Is a cross-sectional view of the alignment bracket shown in FIG. 1;

FIG. 4 Is a cross-sectional view of a second example of a support bracket for installing weatherboard with a cavity spacer;

FIG. 5 Is a cross-sectional view of the alignment bracket shown in FIGS. 1 and 3 for installing weatherboard with a cavity spacer;

FIG. 6 Is a perspective view of a support bracket for installing cladding panels;

FIG. 7 Is a cross-sectional view of the support bracket shown in FIG. 6;

FIG. 8 Shows first and second examples of alignment brackets being used to install cladding panels; and

FIG. 9 Is a cross-sectional view along the line AA of FIG. 8.

### BEST MODES FOR PERFORMING THE INVENTION

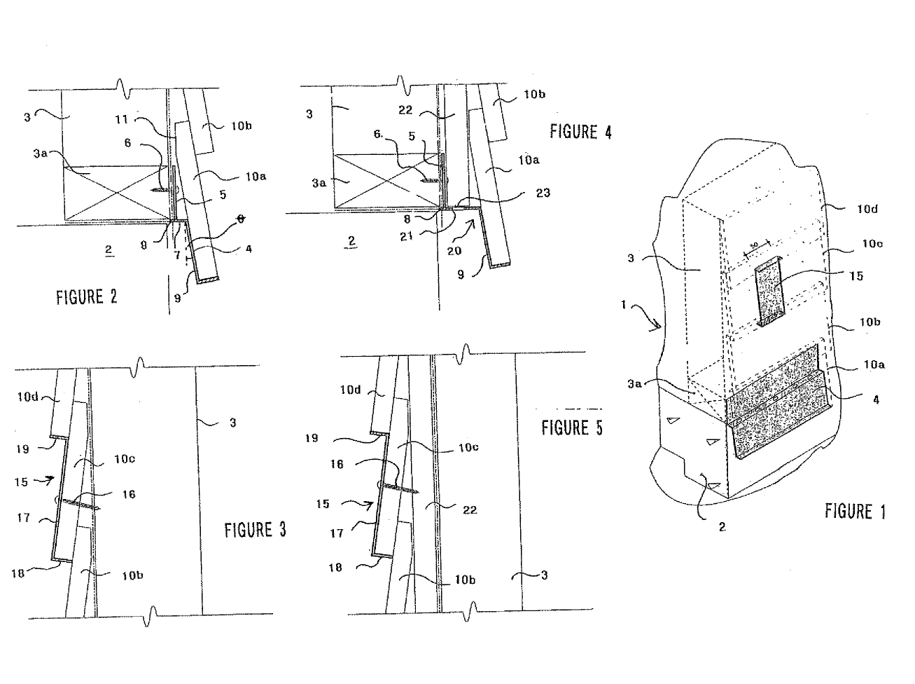

FIG. 1 shows a portion of a building structure 1 which includes foundations 2 and wall framing 3. For purposes of clarity, the wall framing 3 is shown in phantom.

A weatherboard support bracket 4 is attached to the wall framing 3 adjacent to lower beam 3a of the wall framing 3 which is supported on the top of the foundation 2. A cross-section of the support bracket 4 is shown in FIG. 2. The support bracket 4 includes an attachment flange 5 which is attached to the lower beam 3a by a number of fasteners 6 (only one shown), which could be either screws or nails. Attached to the lower end of the attachment flange 5 is an intermediate portion 7 that extends on either side of the flange 5. On one side of the flange 5 the intermediate member 7 defines a lip 8 that engages with a lower edge of the beam 3a to align the support bracket 4 on the beam 3a. On the opposite side of the flange 5 a support portion 9 depends from the intermediate member 7. The support portion 9 is generally L-shaped and extends from the intermediate member 7 downwards at an angle θ to the vertical.

In use, the bracket 4 is positioned with the attachment flange 5 along the side of the lower beam 3a of the framing 3 with the lip 8 engaging the lower edge of the beam 3a to align the bracket 4. When the bracket 4 is in position, the fasteners 6 are inserted through the attachment flange 5 to engage with the lower beam 3a to fix the bracket 4 to the lower beam 3a. Typically, the fasteners 6 are inserted through preformed holes (not shown) in the attachment flange 5. However, it is possible that the fasteners 6 could be driven through the attachment flange 5 without requiring a preformed hole.

After the bracket 4 has been fixed to the wall framing 3, as shown in FIGS. 1 and 2, the first weatherboard 10a is positioned on the support portion 9, as shown in FIGS. 1 and 2. Hence, the angle θ defines the angle of slope of the weatherboard 10a to the vertical. In FIG. 1 the weatherboards 10 are shown in phantom for purposes of clarity. When the first weatherboard 10a, which is the lower most weatherboard, is positioned on the bracket 4, it can be attached to the building structure 1 by driving fasteners, such as nails or screws, through upper section 11 of the weatherboard into the wall framing 3.

FIG. 1 also shows an alignment bracket 15 for aligning and supporting subsequent weatherboards 10b, 10c, 10d for fixing to the building structure 1. FIG. 1 shows the bracket 15 being used to install a further weatherboard 10d above existing weatherboards 10a, 10b, 10c. FIG. 3 shows a cross-sectional view of the bracket 15 being used to install the weatherboard 10d. The bracket 15 includes an intermediate section 17, a lower alignment flange 18 and an upper support flange 19. The bracket 15 is generally Z-shaped with the alignment flange 18 extending substantially perpendicularly from the intermediate section 17 on the opposite side from the side of the intermediate section 17 from which the support flange 19 extends. The support flange 19 also extends generally perpendicularly from the intermediate section 17.

In FIGS. 1 and 3 the weatherboards 10b,10c have already been installed above the first weatherboard 10a using the bracket 15 in the same manner as will be described below for installing the weatherboard 10d.

To install the weatherboard 10d, the bracket 15 is positioned on the weatherboard 10c, as shown in FIGS. 1 and 3 with the alignment flange 18 butting against the lower edge of the weatherboard 10c. This aligns and positions the bracket 15 on the weatherboard 10c and permits a fastener 16, such as a nail or screw, to be inserted through a preformed hole (not shown) in the bracket 15 to secure the bracket 15 to the weatherboard 10c and the wall framing 3. The lower edge of the weatherboard 10d is then rested on top of the support flange 19. The bracket 15 then supports the weatherboard 10d permitting it to be secured to the wall framing 3 using appropriate fasteners, in the same manner that the first weatherboard 10a was fixed to the wall framing 3. After the weatherboard 10d is secured to the wall framing 3, the fastener 16 is removed from the wall framing 3 and the weatherboard 10c thus permitting removal of the bracket 15 and permitting the bracket 15 to be reused for installation of the next weatherboard (not shown) above the weatherboard 10d.

Although in the example described above, only one bracket 4 was used to install the weatherboard 10a and only one bracket 15 was used to install subsequent weatherboards, 10b, 10c, 10d, it is possible that two or more of the brackets 4 and/or the brackets 15 could be used to install the weatherboards 10, especially if the weatherboards 10 are particularly long.

It should also be noted that the bracket 15 is substantially symmetrical about a central axis that is substantially parallel to the flanges 18, 19. This helps to ensure uniform positioning of the weatherboards 10 and also enables the bracket 15 to be used in reverse. That is, with flange 19 as the alignment flange and flange 18 as the support flange. This has the advantage of enhancing ease of use during installation as it is not necessary to ensure that the bracket 15 is the correct way round for installation of each weatherboard to ensure correct installation.

FIG. 4 is a cross-sectional view showing a bracket 20 similar to the bracket 4 except that there is a longer intermediate member 21 to accommodate a cavity spacer 22. Lower edge 23 of the cavity spacer 22 rests on the intermediate member 21. The sections of the bracket 20 that are identical to the bracket 4 are labelled with the same reference numerals as the bracket 4.

In use, the bracket 20 is installed on the lower beam 3a in the same manner as the bracket 4 is installed. Then the cavity spacers 22 are positioned on the intermediate section 21 and fixed to the wall framing 3 before the weatherboard 10a is installed on the bracket 20 in the same manner that weatherboard 10a is installed on the bracket 4 in FIGS. 1 and 2. The only difference is that where cavity spacers 22 are used the weatherboards 10a is secured using fasteners to the cavity spacers 22 instead of to the wall framing 3.

After the first weatherboard 10a has been secured to the cavity spacers 22, the bracket 15 can be used in the same manner as described above to install subsequent weatherboards 10b, 10c, 10d which are also secured using fasteners to the cavity spacers 22 instead of the wall framing 3.

An advantage of installing weatherboard 10 using the brackets 4, 20, 15 is that it ensures that the spacing between adjacent weatherboards is uniform. This has the advantage that it enables preformed moulded scribers to be manufactured in a factory environment away from the construction site. This is possible because the spacing between adjacent weatherboards is uniform and this avoids the labour intensive of requirement of cutting each scriber individually on site to suit the installation of the weatherboards at that particular site.

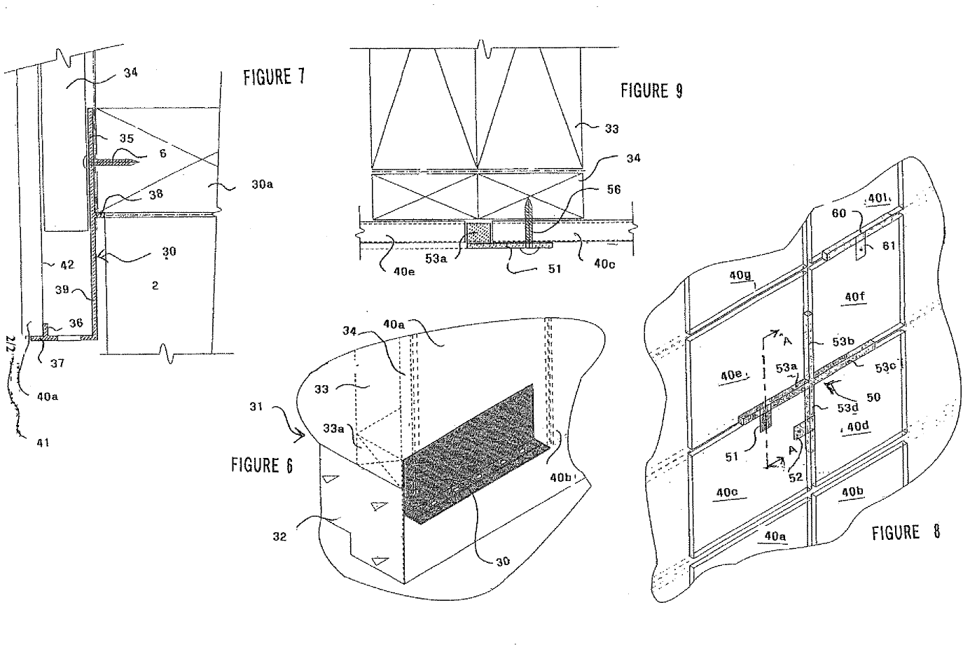

FIG. 6 shows a bracket 30 for installing cladding panels 40 on a building structure 31 which includes foundations 32 supporting wall framing 33.

FIG. 7 shows a cross-section of the bracket 30. The bracket 30 includes an attachment flange 35 and a support portion 39 depending from the attachment flange 35. Where the support portion 39 joins the attachment flange 35, a lip 38 protrudes perpendicularly from the attachment flange 35 and support portion 39 on one side of the flange 35 and support portion 39. The support portion 39 is generally L-shaped with a support member 37 extending outwardly from the support portion 39. The support member 37 includes a lip 36 that extends perpendicularly upwardly from the support member 37.

In use, the bracket 30 is attached to the building structure by positioning the attachment flange 35 on a lower beam 30a of the wall framing 30 such that lip 38 engages with the lower edge of the lower beam 30a. In this position, the bracket 30 is secured to the lower beam 30a by inserting fasteners 6 (only one shown) through preformed holes in the bracket 30 to fix the bracket 30 to the lower beam 30a. As with the brackets 4, 20 described above, the fastener 6 may be inserted through performed holes in the attachment flange 35 or may be driven through the material of the attachment flange 35 during fixing.

When the bracket 30 has been fixed to the wall framing 33, cavity spacers 34 can be positioned on the bracket 30 and secured to the wall framing 33 using appropriate fasteners, such as screws or nails (not shown). A cladding panel 40a is then positioned on the bracket 30 with a lower edge 41 resting on the support member 37 with rear surface 42 of the panel 40 butting against the lip 36, as shown in FIG. 7. When the cladding panel 40 is positioned, as described above and shown in FIGS. 6 and 7, the cladding panel 40a can be secured to the building structure by using fasteners, preferably screws, which are inserted through the panel 40a to engage with the cavity spacers 34.

A separate bracket 30 is used to install the next cladding panel 40b horizontally adjacent to the cladding panel 40a and further brackets 30 are used to install the other cladding panels 40 in the lower most row of cladding panels 40 around the building structure 31.

FIGS. 8 and 9 show first and second examples of cladding panel alignment brackets for positioning subsequent cladding panels 40 above the first row of cladding panels 40. FIG. 8 shows a first example of a cladding panel alignment bracket 50 and a second example of a cladding panel alignment bracket 60.

The cladding panel alignment bracket 50 is in the shape of a cross with two attachment flanges 51, 52 extending from adjacent legs of the cross towards each other. The attachment flanges 51, 52 permit the alignment bracket 50 to be removably attached to an already installed cladding panel 40c by driving a fastener 56 through a preformed hole in the flanges 51, 52 to secure bracket 50 to the panel 40c. In the position, legs 53a, 53d off the bracket 50 but against adjacent edges off the panel 40c, as shown in FIG. 8. This then enables panel 40e to be positioned with adjacent edges butting against legs 53a, 53b of the bracket 50, as shown in FIG. 8 and the cladding panel 40e to be fixed to the building structure using appropriate fasteners to attach the cladding panel 40e to the cavity spacers 34. Similarly, the cladding panel 40f can be positioned with adjacent edges butting against legs 53b, 53c of the bracket 50 and similarly secured to the building structure.

Hence the bracket 50 enables cladding panels above the lowest row of cladding panels 40 to be positioned and fixed to the building structure 31 by providing for uniform spacing between adjacent panels and also providing support for the panels during the fixing operation.

The cladding panel alignment bracket 60 is effectively formed from one of the legs of the bracket 50 with an attachment flange 61. The bracket 60 also provides a support for a subsequent panel 40h to be installed and ensures uniform spacing between it and the previously installed cladding panel 40f. However, more care is required to ensure that the horizontal spacing between the panels is maintained uniform. For this reason, the bracket 50 is preferred over the bracket 60 for installing subsequent panels as it helps to ensure that both the vertical and horizontal spacing between panels is the same.

Hence, the bracket 30 enables the lower most row of cladding panels 40 to be mounted on and secured to a building structure 31 and the brackets 50, 60 enable cladding panels 40 above the lower most row to be installed with uniform spacing. The brackets 50, 60 also provide a support for the installation of the panels 40 during fixing.

Furthermore, it should be noted that the brackets 50, 60 are removable so that they can be reused for installation of further panels 40.

Advantages of the invention include facilitating uniform spacing between cladding elements, such as weatherboard or cladding panels, during installation of the cladding elements to a building structure and providing a support for the cladding elements during fixing of the cladding elements to the building structure to enable the cladding elements to be fixed more easily to the building structure.

1-24. (canceled)

25. A cladding support bracket for positioning and supporting a cladding element for attachment to a building structure, the bracket comprising a support portion provided with a first support member adapted to receive a lower edge of a cladding element and an attachment member adapted to be attached to the building structure, wherein the first support member is coupled to the attachment member, the bracket further comprising a second support member adapted to support a cavity spacer.

26. A bracket according to claim 25, wherein the bracket is shaped and configured to support a cladding panel.

27. A bracket according to claim 26, wherein the second support member extends substantially perpendicularly to the attachment member and the first support member is substantially parallel to the second support member.

28. A bracket according to claim 25, wherein the first support member is in line with the second support member.

29. A bracket according to claim 25, wherein the bracket is shaped and configured to support a weatherboard.

30. A bracket according to claim 29, wherein the second support member separates the support portion from the attachment member.

31. A bracket according to claim 29, wherein the support portion extends at an angle to the attachment member and at an angle to the second support member.

32. A bracket according to claim 25, wherein the bracket comprises an alignment protrusion that is adapted to engage with the building structure to aid alignment of the bracket relative to the building structure.

33. A bracket according to claim 32, wherein the protrusion is an elongate protrusion.

34. A bracket according to claim 33, wherein the elongate protrusion is in the form of a lip.

35. A bracket according to claim 25, wherein the bracket is adapted to support and/or align the lowermost row of cladding elements or a cladding element in the lowermost row.

36. A method of installing cladding elements on a building structure, the method comprising attaching to the building structure a first device for positioning and supporting a cladding element on the building structure, the first device including a support portion provided with a first support member that extends away from the building structure when the support device is attached to the building structure, and a second support member adapted to support a cavity spacer, the first device being attached to the building structure such that the first support member extends substantially horizontally along the building, positioning a first cladding element on the first device such that a lower edge of the cladding element engages with the support member and fixing the first cladding element to the building structure.

37. A method according to claim 36, further comprising removably engaging a second device with the first cladding element, the second device including a support member having a support surface for engaging with an edge of a second cladding element, positioning the second cladding element on the building structure such that an edge of the second cladding element engages with the support member and fixing the second cladding element to the building structure.

38. A method according to claim 37, wherein the second device is removed from the first cladding element after the second cladding element has been fixed and is repeatedly attached and removed from subsequent cladding elements until all the cladding elements have been mounted on the building structure.

39. A method according to claim 37, wherein the cladding elements are weatherboard and the second device has an alignment member that engages with a lower edge of the previously fixed weatherboard to align the support member which is engaged by the weatherboard to be fixed.

40. A method according to claim 39, wherein the second device has a generally “Z” shaped profile.

41. A method according to claim 36, wherein the cladding elements to be mounted on the building structure are cladding panels, the second device comprising four legs in the shape of a cross, with a width of the legs of the cross defining a separation between adjacent cladding panels.

42. A method according to claim 41, wherein at least one leg of the cross has an attachment member to enable the second device to be removably attached to an existing cladding panel.

43. A method according to claim 36, wherein the cladding elements are cladding panels, the second device comprising an elongate member having an attachment member extending transverse to the extent of the elongate member, the elongate member engaging with an edge of the cladding panel that has already been installed to define the support surface of a subsequent cladding panel to be installed and defining the separation of the subsequent cladding panel from the existing panel, the attachment member extending over the existing cladding panel for removable attachment to the existing cladding panel.
